(19) United States
(12) Patent Application Publication
(10) Pub. No.: US 2023/0080453 A1
(43) Pub. Date: Mar. 16, 2023

(54) AUTOMATED WELL ANNULI INTEGRITY ALERTS

(71) Applicant: Saudi Arabian Oil Company, Dhahran (SA)

(72) Inventors: Muhammad Idris, Udhailiyah (SA); Emad Abbad M. Alabbad, Dammam (SA)

(21) Appl. No.: 17/473,389

(22) Filed: Sep. 13, 2021

(51) Int. Cl. G08B 21/18; E21B 47/06; E21B 47/10

(52) U.S. Cl. CPC G08B 21/182; E21B 47/06; E21B 47/10

(57) ABSTRACT

A system and methods for automated well annuli integrity alerts are provided. An exemplary method provides evaluating a wellhead tubing pressure, a plurality of annuli pressures, a choke valve value, and flowrate at a well surface of a well in real-time. An automated alert is generated in response to the wellhead tubing pressure, a plurality of annuli pressures, a choke valve value, and flowrate satisfying at least one condition. A user is advised of at least one well action to resolve the automated alert, wherein the advising is interactive messaging that provides well actions to resolve the automated alert.

### TECHNICAL FIELD

The present disclosure describes automated alerts and, more particularly, automated well annuli integrity alerts.

### BACKGROUND

Generally, a well architecture includes a series of casings that provide structural integrity for the well and prevent a collapse of the borehole wall. The casings prevent an outflow of drilling fluids into the surrounding formation and an inflow of fluids from the formation into the borehole. The casing is fixed in the borehole by a cement layer between the outer wall of the casing and the wall of the borehole. During the drilling of the wellbore, annuli are created between the tubing, casings, and the borehole wall.

### SUMMARY

An embodiment described herein provides automated well annuli integrity alerts. A wellhead tubing pressure, plurality of annuli pressures, choke valve value, and flowrate are evaluated at a well surface of a well in real-time. An automated alert is generated in response to the wellhead tubing pressure, plurality of annuli pressures, choke valve value, and flowrate satisfying at least one condition. A user is advised of at least one well action to resolve the automated alert, wherein the advising is interactive messaging that provides well actions to resolve the automated alert.

### BRIEF DESCRIPTION OF DRAWINGS

FIG. 1 is an illustration of a well with surface pressure readings.

FIG. 2 is an illustration of a system that enables well annuli integrity alerts.

FIG. 3 is an illustration of a process that enables well annuli integrity alerts.

FIG. 4 is a block diagram of an interactive report generated according to the present techniques.

FIG. 5 is a process flow diagram of a process for automated well annuli integrity alerts.

FIG. 6 is a schematic illustration of an example control system for automated well annuli integrity alerts.

### DETAILED DESCRIPTION

Embodiments described herein enable automated well annuli integrity alerts. The disclosure describes an integrated method and process to determine if a condition that indicates a well annuli integrity issue exists at a well. Further, the method and process provide alerts related to the well annuli integrity issues in real-time. The present techniques provide automatic notification of potential well annuli integrity issues and provides interactive advice that further enables tracking and managing the well actions for resolving the issue. Abnormalities in annulus pressure are detected, alerted, and acted upon before well annuli integrity is compromised.

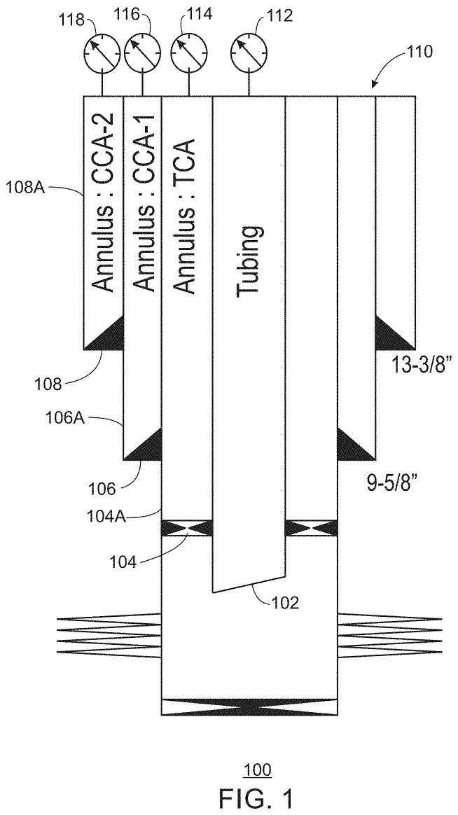

FIG. 1 is a cross section of a well 100 with surface pressure readings. As illustrated, the well 100 includes tubing 102, an annulus 104, an annulus 106, and an annulus 108. The annulus 104, annulus 106, and annulus 108 are collectively referred to as annuli. In embodiments, the well 100 is an oil well, a gas well, and oil and gas well, or any combinations thereof. During the drilling of the well 100, a drill bit located at a lower end of a drill string is driven into a formation to create a wellbore. The drill bit rotates while force is applied through the drill string and against a rock face of the formation being drilled. After drilling to a predetermined depth, the drill string and bit are removed and the wellbore is lined with a string of casing. An annular area (e.g., annulus) is formed between the string of casing and the formation penetrated by the wellbore.

In some cases, a cementing operation is performed in order to fill the annular area with a column of cement. During drilling of the well 100, the annulus 104, annulus 106, and annulus 108 (e.g., annuli) are created between the outer surfaces of the casings 104A, 106A, and 108A. The combination of cement and casing provides structure that strengthens the wellbore and prevents undesired inflows and outflows of oil, gas, or other fluids at the wellbore. A casing is commonly cemented in place after the installation of each casing. The cement sets up in the annulus, supporting and positioning the casing and forming a substantially impermeable barrier which divides the well bore into subterranean zones. Generally, for each casing or tubing, a pressure threshold is specified according to the assigned tubing or casing design, including a size of the tubing or casing and a grade of the materials used. In the example of FIG. 1, the annulus 108 is 13⅜ feet in width, while the annulus 106 is 9⅝ feet in width. In embodiments, the pressure threshold is recalculated when different mechanical strengths/properties of the tubing and casing are determined.

During drilling of the well 100, progressively smaller strings of casing are cemented until the well has reached a final depth. Each casing is a physical string of pipes landed in the drilled hole and cemented against the underground formation. The main distinctions between the various casings is their size and the grade of the material used. As illustrated, production tubing 102 is included in the well 100 within a series of casings 104A, 106A, and 108A. In examples, the tubing 102 extends from a surface 110 of the well 100 to a designated depth that is near a production interval of the well 100. In embodiments, the tubing 102 is attached to a packer. In examples, the packer functions to seal off annular space between the tubing and the surrounding casing. The production tubing provides a conduit through which hydrocarbons or other formation fluids may flow to the surface for recovery.

As illustrated in FIG. 1, four surface pressure readings can be obtained at the well 100: Wellhead-Tubing Pressure (WHP) 112, Tubing-Casing Annulus Pressure (P_{TCA}) 114, Casing-Casing Annulus #1 Pressure (P_{CCA-1}) 116, and Casing-Casing Annulus #2 Pressure (P_{CCA-2}) 118. In embodiments, the WHP and annular pressures (e.g., P_{TCA}, P_{CCA-1}, P_{CCA-1}) are measured through a transmitter and/or gauges connected to each surface tubing/casing valves mounted on wellhead assemblies. In examples, the Well Head Tubing Pressure 112 is a measure of pressure on the tubing 102 in the well 100, as measured at the wellhead. The Tubing-Casing Annulus Pressure 114 is a measure of pressure at an annulus 104 between tubing 102 and a first casing 104A (the smallest casing string) as measured at the wellhead. The Casing-Casing Annulus #1 Pressure 116 is a measure of pressure at an annulus 106 between the first casing 104A and the second casing 106A as measured at the wellhead. The Casing-Casing Annulus #2 Pressure 118 is a measure of pressure at an annulus between the second casing 106A and the third casing 108A as measured at the wellhead. For ease of description, the present techniques are described using four surface pressures. However, the present techniques can be used with greater or fewer surface pressures. For example, an additional casing can be used, which creates a Casing-Casing Annulus #3 Pressure (P_{CCA-3}), which is a measure of pressure at an annulus between a third casing and a fourth casing.

The present techniques provide automated well annuli integrity alerts applicable to the full life-cycle of a well. For example, alerts are provided immediately after drilling is completed. The alerts are generated in response to annuli integrity issues at the well. Annuli integrity issues are determined according to one or more conditions. A first condition is a high positive pressure above a predetermined threshold on one or more annuli (e.g., high tubing-casing annular (TCA) pressure, high casing-casing annular (CCA) pressure). The pressures evaluated may be, for example, a tubing-to-casing annular pressure (e.g., Tubing-Casing Annulus Pressure 114), casing-to-casing annular pressure (e.g., Casing-Casing Annulus #1 Pressure 116 and Casing-Casing Annulus #2 Pressure 118) or any combinations thereof. This condition will cause the differential pressure across the tubing and/or any casing string is near its collapse or burst pressure rating. A second condition is an indication from downhole communications that a packer leak, tubing leak, poor cementing, or casing leak is present. In examples, a downhole communication is established between a one or more annuli (e.g., annulus 104, annulus 106, and annulus 108) with the pressure source (reservoir or aquifer). In embodiments, this communication will cause the presence of a corrosive fluid in the annulus 104, annulus 106, or annulus 108. Further, the communication can indicate that the differential pressure across the tubing and/or any casing string is near its collapse or burst pressure rating.

A third condition is a zero pounds per square in gauge (psig) of Tubing-Casing Annulus Pressure 114 pressure while the well is on production (e.g., zero TCA). This category includes the Tubing-Casing Annulus Pressure 114 value between 0 and −15 psig (−1 bar). The Tubing-Casing Annulus Pressure 114 values can change according to the well state: shut-in or flowing. In examples, under shut-in condition, the Tubing-Casing Annulus Pressure 114 pressure might be zero. In examples, under flowing conditions, the Tubing-Casing Annulus Pressure 114 pressure is positive due to thermal expansion effects for the well completed with inhibited fluids in the annulus 104 (diesel or water). When the Tubing-Casing Annulus Pressure 114 of flowing well is recorded with zero pressure, it could indicate a well integrity problem due to one or more of the boundaries (downhole packer, tubing and casing) losing their effectiveness.

A fourth condition is freezing and/or negative annuli pressure. Freezing-annuli pressure is when the annuli pressure is stagnant or constant (no change) over time due to pressure gauge, transmitter malfunction, or data-communication issues. Negative-annuli pressure is when the annuli pressure value is lower than −15 psig (−1 bar) due to pressure gauge/transmitter faults. Accordingly, freezing or negative annuli pressures often result from pressure transmitter/gauge malfunction. Generally, well integrity issues further include deficiencies in cement bonding, corrosion, erosion, load issues, fatigue, and scale. Additional well integrity issues include a malfunction or failure of barrier elements that generates a downhole or surface communication between a source of pressure within the well and an annulus. If the annuli pressures beyond predefined thresholds are not detected, controlled, and managed, well asset damage as well as a negative impact on safety and the environment due to an uncontrolled release of high-pressure hydrocarbon fluids from reservoir to the surface can occur. In embodiments, the predefined thresholds are based on, at least in part the assigned tubing or casing design, including a size of the tubing or casing and a grade of the materials used to form the tubing or casing.

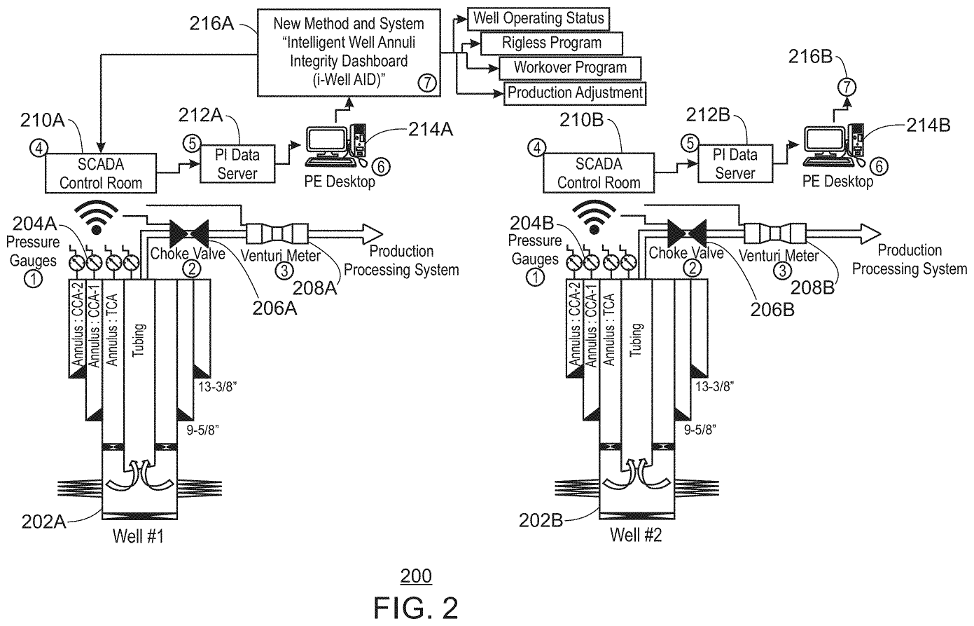

FIG. 2 is an illustration of a system 200 that enables well annuli integrity alerts. In the example of FIG. 2, the system 200 provides real-time measurement of surface pressures and flow rate. The present techniques can be applied to multiple wells. Accordingly, FIG. 2 includes a well 202A and 202B. The wells 202A and 202B, may be, for example, the well 100 of FIG. 1.

In embodiments, four surface pressure reading-sensors 204 measure surface pressure and transmit measured pressures to a control room 210 and data server 212 in real-time mode. In examples, the control room 210 is a supervisory control and data acquisition (SCADA) control room, and the data server 212 is a PI data server. Additionally, a state of a choke valve 206 and a flowrate from a flow measuring device 208 are transmitted to a SCADA control room 210 and PI data server 212 in real-time mode. The data from the PI data server 212 can be accessed through desktop 214, which will be accessed by a user, such as a production engineer, for daily well performance monitoring and evaluation.

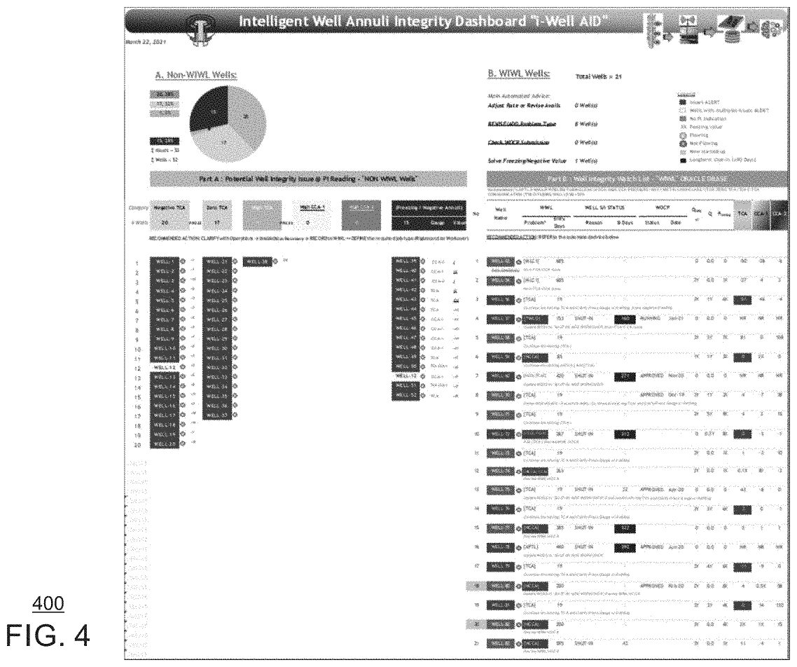

An intelligent well annuli integrity dashboard (i-Well AID) 216 is rendered by the desktop 214. The dashboard 216 may be, for example, the exemplary intelligent well annuli integrity dashboard 400 illustrated in FIG. 4. In embodiments, the dashboard 216 highlights and alerts any potential annulus issues at a well. The dashboard provides a well operating status, and supports management of well actions, such as a rigless program, workover program, and production adjustments.

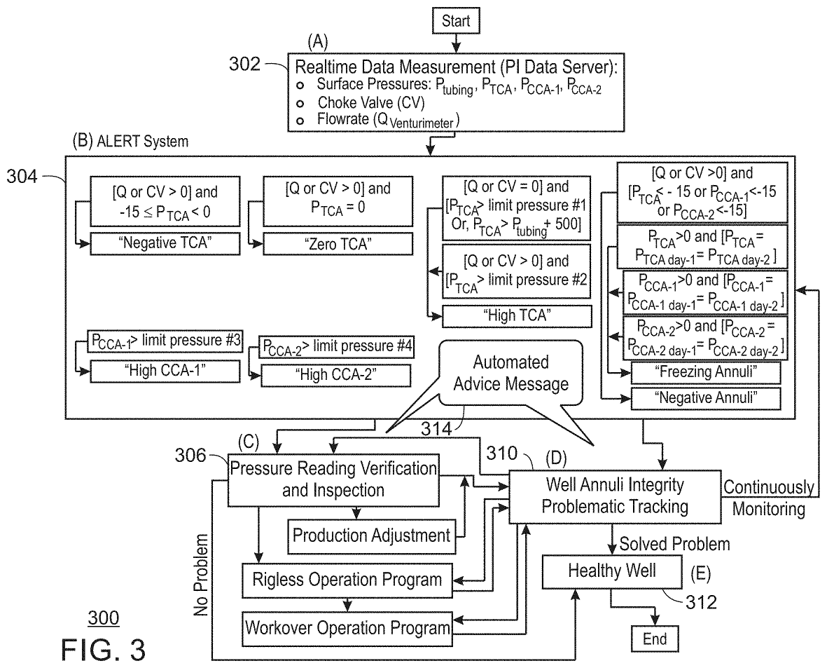

FIG. 3 is an illustration of a process 300 that enables well annuli integrity alerts. In FIG. 3, block 302 obtains real time data. The real time data may be obtained from a PI data server such as, for example, the PI data servers 212A and 212B of FIG. 2. In an example, a PI data server includes application software for real-time data management. In particular, the PI data server is used to capture, process, analyze, and store real-time data according to a particular information infrastructure. The present techniques are not limited to the use of a PI data server, and any data server can be used according to the present techniques.

At block 304, an alert system generates one or more alerts based on real time data obtained by at block 302. In embodiments, the alerts generated include, but are not limited to, negative TCA, zero TCA, high TCA. High CCA-1, high CCA-2, freezing annuli, and negative annuli. In embodiments, the alert system generates automated advice messages 314.

The alerts are rendered or communicated by a dashboard as described above. In examples, the dashboard also renders the real-time data measurements from the PI data server. Accordingly, pressure reading verification and inspection occurs at block 306. Based on the data verified and inspected at block 306, one or more well actions are taken to address the issue or condition identified by an alert. Well actions include, for example, production adjustment 306-1, a rigless operator program 306-2, a workover operation program 306-3, or any combinations thereof.

Generally, production adjustment 306-1 modifies a rate of production. In a rigless operator program 306-2, a well-intervention operation is conducted with equipment and support facilities that do not require the use of a conventional workover rig over the wellbore. Slickline, e-line, and coiled tubing activities are commonly conducted as rigless operations. In resolving a well annuli integrity issue, a type of required rigless operation is implemented, such as a tubing bonnet test, TCA-CCA communication program, TCA refilling work, or setting a plug to isolate wellbore prior workover job. In a workover operation program 306-3, a workover refers to any downhole operation in an existing well that is designed to repair downhole communication normally through a tubing replacement. In examples, “workover” does not refer to routine maintenance routine repair, or like for-like replacement of downhole equipment such as tubing packers or another mechanical device.

The pressure reading verification and inspection at block 306, along with the well actions 306-1, 306-2, and 306-3 are used for well annuli integrity problem tracking at block 310. The well annuli integrity problem tracking at block 310 provides feedback to the pressure reading verification and inspection at block 306, along with the well actions 306-1, 306-2, and 306-3. When no issues remain for a well, it is identified as a healthy well at block 312.

In embodiments, the pressure reading verification and inspection at block 306, along with the well actions 306-1, 306-2, and 306-3 are realized via automated advice messages 314 generated by the alert system 304. The automated advice messages 314 includes pressure transmitter verification and calibration; production/target adjustment; well-operating status updating; rigless program requirements; workover program requirement/submissions; and annuli integrity problem category tracking.

In operation, the process 300 proceeds as follows. At block 302, real-time data is obtained by real time, physical data measurement. In examples, there are six (6) main parameters transmitted to the alert system at block 304: Wellhead-Tubing Pressure (WHP), tubing-casing annulus pressure (P_{TCA}), casing-casing annulus #1 pressure (P_{CCA-1}), casing-casing annulus #2 pressure (P_{CCA-2}), a choke valve position (e.g., choke valve value), and a flowrate. Thus, in addition to the surface pressure measurements (e.g., WHP, P_{TCA}, P_{CCA-1}, P_{CCA-2}), the position of a choke-valve (e.g., open or closed) and a flowrate from a Venturimeter are also measured and transmitted to SCADA control room and PI data server in real-time. A choke valve value of zero indicates a closed choke value, while a choke valve value greater than zero corresponds to an open position of the choke valve.

At block 304, an alert system generates alerts. After receiving the real-time data obtained at block 302, alerts are determined automatically (e.g., automated alerts) based on one or more predefined conditions. The alerts are recorded by the alert system. In examples, there are seven (7) alerts recognized using the surface pressure readings, choke valve position, and flowrate: Negative TCA, Zero TCA, High TCA, High CCA-1, High CCA-2, Negative Annuli (out of Negative TCA group), and Freezing Annuli values. In examples, alerts are recorded at block 310 in a well annuli integrity problem tracking system. The well annuli problem tracking system at block 310 is updated with new alerts directly from the alert system at block 304.

In embodiments, a number of evaluations are continually executed to detect well annuli integrity issues. The evaluations each are indicative of well annuli integrity issues, as they can indicate a malfunction or failure of barrier elements (e.g., cement, casings, etc.) that develops and causes a downhole or surface communication between a source of pressure within the well and an annulus.

To generate a Negative TCA alert, the flowrate, choke valve position, and Tubing-Casing Annulus Pressure (P_{TCA}) are evaluated. In particular, if the flowrate and choke valve value are greater than zero, and the Tubing-Casing Annulus Pressure (P_{TCA}) is less than zero and greater than or equal to negative fifteen psig, a Negative TCA alert is generated.

Similarly, to generate a Zero TCA alert, the flowrate, choke valve position, and Tubing-Casing Annulus Pressure (P_{TCA}) are evaluated. In particular, if the flowrate and choke valve value are greater than zero, and the Tubing-Casing Annulus Pressure (P_{TCA}) is equal to zero, a Zero TCA alert is generated.

To generate a High TCA alert, the flowrate, choke valve position, Tubing-Casing Annulus Pressure (P_{TCA}), and Wellhead-Tubing Pressure (WHP) are evaluated. In a first evaluation, if the flowrate and choke valve value equal to zero, and the Tubing-Casing Annulus Pressure (P_{TCA}) is greater than a first limit pressure or the Tubing-Casing Annulus Pressure (P_{TCA}) is greater than the Wellhead-Tubing Pressure (WHP) plus 500 psig, a High TCA alert is generated. In a second evaluation, if the flowrate and choke valve value are greater than zero, and the Tubing-Casing Annulus Pressure (P_{TCA}) is greater than a second limit pressure, a High TCA alert is generated. Note that the first limit pressure and the second limit pressure are the maximum allowable pressure in TCA for the shut-in and flowing conditions, respectively. The limit pressure is defined based on a maximum internal yield (burst) and/or collapse pressure of tubing and casing after applying with certain safety factor.

To generate a High CCA-1 alert, the Casing-Casing Annulus #1 Pressure (P_{CCA-1}) is evaluated. If the Casing-Casing Annulus #1 Pressure (P_{CCA-1}) is greater than a third limit pressure, a High CCA-1 alert is generated. Similarly, to generate a High CCA-2, the Casing-Casing Annulus #2 Pressure (P_{CCA-2}) is evaluated. If the Casing-Casing Annulus #2 Pressure (P_{CCA-2}) is greater than a fourth limit pressure, a High CCA-2 alert is generated. Note that the third limit pressure and the fourth limit pressure are referred to as the Increasing Monitoring Trigger Level (IMTL) for the CCA-1 and CCA-2 respectively. The limit pressure is defined based on which one is the lesser of the maximum internal yield pressure of the outer or next outer casing and the maximum collapse pressure of the inner casing after applying with certain safety factor. In embodiments, the IMTL is the maximum limit of normal or safe pressures of the CCAs. If a CCA pressure is exceeds the IMTL, additional surveillance or rigless activities are implemented confirm the abnormality of the pressure reading and then to determine the required action for solving the well annuli integrity problem.

To generate a Negative Annuli (out of Negative TCA group) alert, the flowrate, choke valve position, Tubing-Casing Annulus Pressure (P_{TCA}), Casing-Casing Annulus #1 Pressure (P_{CCA-1}), and Casing-Casing Annulus #2 Pressure (P_{CCA-2}) are evaluated. In particular, if the flowrate and choke valve value are greater than zero and any one of the Tubing-Casing Annulus Pressure (P_{TCA}), Casing-Casing Annulus #1 Pressure (P_{CCA-1}), or Casing-Casing Annulus #2 Pressure (P_{CCA-2}) are less than negative fifteen psig, a negative annuli alert is generated.

To generate a Freezing Annuli alert, the Tubing-Casing Annulus Pressure (P_{TCA}), Casing-Casing Annulus #1 Pressure (P_{CCA-1}), and Casing-Casing Annulus #2 Pressure (P_{CCA-2}) are evaluated. In a first evaluation, if the Tubing-Casing Annulus Pressure (P_{TCA}) is greater than zero and the Tubing-Casing Annulus Pressure (P_{TCA}) substantially equals the Tubing-Casing Annulus Pressure (P_{TCA}) from the day prior, which substantially equals the Tubing-Casing Annulus Pressure (P_{TCA}) from two days prior, a freezing annuli alert is generated. In a second evaluation, if the Casing-Casing Annulus #1 Pressure (P_{CCA-1}) is greater than zero and the Casing-Casing Annulus #1 Pressure (P_{CCA-1}) substantially equals the Casing-Casing Annulus #1 Pressure (P_{CCA-1}) from the day prior, which substantially equals the Casing-Casing Annulus #1 Pressure (P_{CCA-1}) from two days prior, a freezing annuli alert is generated. In a third evaluation, is the Casing-Casing Annulus #2 Pressure (P_{CCA-2}) is greater than zero, and the Casing-Casing Annulus #2 Pressure (P_{CCA-2}) substantially equals the Casing-Casing Annulus #2 Pressure (P_{CCA-2}) from the day prior, which substantially equals the Casing-Casing Annulus #2 Pressure (P_{CCA-2}) from two days prior, a freezing annuli alert is generated.

In embodiments, when generating a freezing annuli alert, the pressures are substantially equal when the pressures are each within a predetermined range. In embodiments, when the pressures are exactly equal in order to generate a freezing annuli alert. Additionally, for ease of description, the Freezing Annuli alert is described as comparing a current pressure measurement to pressure measurements from one day prior and two days prior. However, the prior pressure measurements can be obtained from any point in time prior to the current pressure measurement and are not limited to the particular times described above.

At block 306, the data used to generate alerts according to the above evaluations is verified and inspected, and one or more well actions can be taken to address the issue or condition identified by an alert. For example, the surface pressure of the alerted wells is further verified or calibrated to ensure the reliability and accuracy prior moving forward to next steps, such as well actions. In embodiments, verification of the pressure readings that caused the alert generation is performed visually and directly using a manual pressure gauge. In case the real-time reading does not match the manual gauge, the calibration will be conducted on the pressure transmitter. In embodiments, if the surface pressures are not verified, further well actions are misleading and result in unnecessary costs.

After confirming the pressure reading at the wellsite, a type of well action is executed to resolve the alert. Well actions include adjusting the production rate (e.g., production rate adjustment 306-1), closing the well, well annuli integrity problem category updating, a rigless operation program 306-2, and/or workover operation program 306-3, or any combinations thereof. The well actions are implemented to reduce or eliminate the well annuli integrity issues that caused the alert.

At block 310, problem wells are tracked. In well annuli integrity problem tracking, all verified results obtained from the pressure reading verification and inspection at block 306 are stored in a tracking system. All alerts are recorded in an assigned database where the type of annuli problem, the executed well action, and the action progress are monitored automatically. The tracking system is continuously updated and communicatively coupled with the alert system at block 304. The well actions (e.g., well actions 306-1, 306-2, and 306-3) implemented to resolve the issue at each well is also stored by the tracking system. In embodiments, when a well is associated with one or more annuli issue alerts it is identified as a problem well. At block 312, healthy wells are labeled as being healthy wells, without a current alert indicated at the well. In a healthy well, the annuli integrity issue of the alerted wells has been resolved. When a well is healthy, it is removed from the tracking system and will be categorized as a healthy well.

FIG. 4 is a block diagram of a dashboard 400 including an interactive report generated according to the present techniques. An alert is generated according to the evaluations of real-time data as described with respect to FIG. 3. The dashboard 400 can present information to a user for a plurality of wells.

In examples, once the alert is triggered or received, all potential problem wells are recorded into an assigned database that should include but are not limited to the type of problem, general action (pressure clarification reading) and specific action (TCA-CCA communication diagnostic). This information may be presented to a user by the dashboard 400. The surface pressure reading is verified using a manual gauge. If the problem is not real or due to pressure transmitter malfunction, the well is flagged as a healthy-well. Healthy wells may be presented to a user by the dashboard 400. In examples, a tubing bonnet test is performed through a rigless operations to ensure no TCA communication at surface. Repairing of the wellhead is continued if the TCA communication at surface is due to wellhead pack-off damage or leak. If the TCA communication is not provided at the surface, a workover program is issued to conduct a workover operation to fix the downhole communication through a tubing replacement or casing squeezed and scab-liner. In embodiments, the dashboard 400 enables management of the rigless operations and workover program.

In examples, next a TCA-CCA communication test is performed through a rigless operations to confirmed sustained TCA or CCA communication. If the sustained TCA/CCA is confirmed, enable zonal isolation by setting a plug through a rigless operations prior workover program. Finally, a workover program is issued to conduct a workover operation to fix the downhole communication through a tubing replacement or casing squeezed and scab-liner. The examples provided herein are exemplary and should not be viewed as limiting. In embodiments, actions implemented to resolve an alert change subject to the severity, type, or number of alerts.

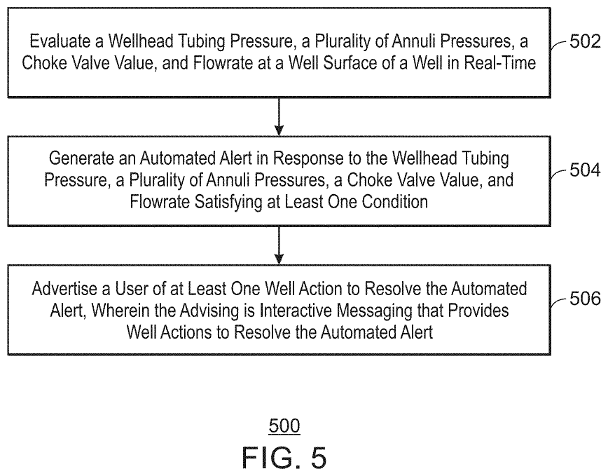

FIG. 5 is a process flow diagram of a process 500 for automated well annuli integrity alerts.

At block 502, a wellhead tubing pressure, a plurality of annuli pressures, a choke valve value, and flowrate are evaluated at a well surface of a well in real-time.

At block 504, an automated alert is generated in response to the wellhead tubing pressure, a plurality of annuli pressures, a choke valve value, and flowrate satisfying at least one condition.

At block 506, a user is advised of at least one well action to resolve the automated alert, wherein the advising is interactive messaging that provides next actions to resolve the automated alert.

In embodiments, the present techniques ensure that any abnormality in annulus pressure is detected, alerted and acted upon prior to compromising well annuli integrity. Verification of the surface pressure prior to issuing an alert reduces false positives. In examples, verification of the surface pressures is a confirmation of the accuracy of detected pressures at the well head.

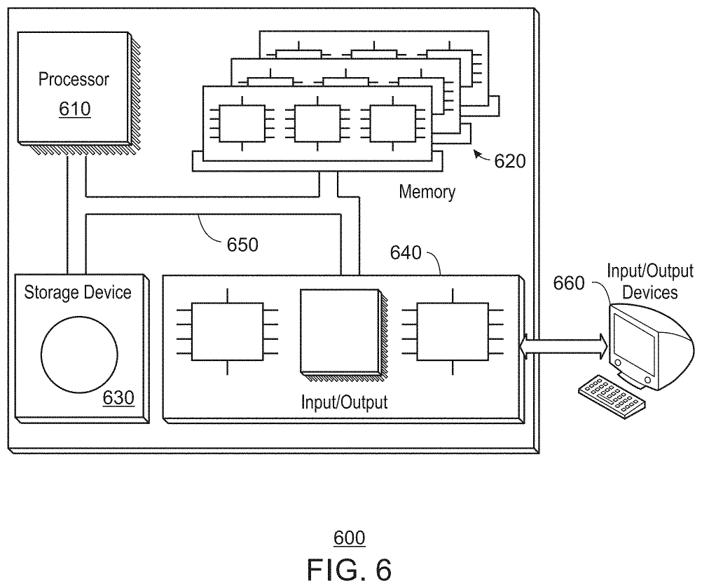

FIG. 6 is a schematic illustration of an example controller 600 (or control system) for automated well annuli integrity alerts according to the present disclosure. For example, the controller 600 may include or be part of the supply chain 100 shown in FIG. 1 operable according to the process 300 of FIG. 3 or the process 500 of FIG. 5. The controller 600 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 600 includes a processor 610, a memory 620, a storage device 630, and an input/output interface 640 communicatively coupled with input/output devices 660 (e.g., displays, keyboards, measurement devices, sensors, valves, pumps). Each of the components 610, 620, 630, and 640 are interconnected using a system bus 650. The processor 610 is capable of processing instructions for execution within the controller 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output interface 640.

The memory 620 stores information within the controller 600. In one implementation, the memory 620 is a computer-readable medium. In one implementation, the memory 620 is a volatile memory unit. In another implementation, the memory 620 is a nonvolatile memory unit.

The storage device 630 is capable of providing mass storage for the controller 600. In one implementation, the storage device 630 is a computer-readable medium. In various different implementations, the storage device 630 may be a floppy disk device, a hard disk device, an optical disk device, or a tape device.

The input/output interface 640 provides input/output operations for the controller 600. In one implementation, the input/output devices 660 includes a keyboard and/or pointing device. In another implementation, the input/output devices 660 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

Other implementations are also within the scope of the following claims.

What is claimed is:

1. A computer-implemented method for automated well annuli integrity alerts, the method comprising:
evaluating, with one or more hardware processors, a wellhead tubing pressure, a plurality of annuli pressures, a choke valve value, and flowrate at a well surface of a well in real-time;
generating, with one or more hardware processors, an automated alert in response to the wellhead tubing pressure, plurality of annuli pressures, choke valve value, and flowrate satisfying at least one condition; and
advising, with one or more hardware processors, a user of at least one well action to resolve the automated alert, wherein the advising is interactive messaging that provides well actions to resolve the automated alert.

2. The computer-implemented method of claim 1, comprising verifying existence of the at least one condition that caused the generation of the automated alert prior to advising the user.

3. The computer-implemented method of claim 1, wherein upon resolution of the automated alert, categorizing the well as a healthy well.

4. The computer-implemented method of claim 1, wherein the automated alert is stored by a tracking system, and the tracking system is updated according to well actions taken at the well.

5. The computer-implemented method of claim 1, wherein the automated alert is rendered at a dashboard of a data server.

6. The computer-implemented method of claim 1, wherein the automated alert is a negative tubing-to-casing annular alert and is generated when the flowrate and choke valve value are greater than zero, and a Tubing-Casing Annulus Pressure is less than zero and greater than or equal to negative fifteen psig.

7. The computer-implemented method of claim 1, wherein the automated alert is a zero tubing-to-casing annular alert and is generated when the flowrate and choke valve value are greater than zero, and a Tubing-Casing Annulus Pressure is equal to zero.

8. The computer-implemented method of claim 1, wherein the automated alert is a high tubing-to-casing annular alert and is generated when:
the flowrate and choke valve value equal zero and a Tubing-Casing Annulus Pressure is greater than a first limit pressure or the Tubing-Casing Annulus Pressure is greater than a Wellhead-Tubing Pressure plus 500 psig; or
the flowrate and choke valve value are greater than zero, and the Tubing-Casing Annulus Pressure is greater than a second limit pressure.

9. The computer-implemented method of claim 1, wherein the automated alert is a high first casing-to-casing annular alert and is generated when a Casing-Casing Annulus #1 Pressure is greater than a third limit pressure.

10. The computer-implemented method of claim 1, wherein the automated alert is a high second casing-to-casing annular alert and is generated when a Casing-Casing Annulus #2 Pressure is greater than a fourth limit pressure.

11. The computer-implemented method of claim 1, wherein the automated alert is a negative annuli and is generated when the flowrate and choke valve value are greater than zero and any one of a Tubing-Casing Annulus Pressure, Casing-Casing Annulus #1 Pressure, or Casing-Casing Annulus #2 Pressure are less than negative fifteen psig.

12. The computer-implemented method of claim 1, wherein the automated alert is a freezing annuli and is generated when:
a Tubing-Casing Annulus Pressure is greater than zero and the Tubing-Casing Annulus Pressure substantially equals a Tubing-Casing Annulus Pressure from a day prior, which substantially equals a Tubing-Casing Annulus Pressure from two days prior;
a Casing-Casing Annulus #1 Pressure is greater than zero and the Casing-Casing Annulus #1 Pressure substantially equals a Casing-Casing Annulus #1 Pressure from a day prior, which substantially equals a Casing-Casing Annulus #1 Pressure from two days prior; or
a Casing-Casing Annulus #2 Pressure is greater than zero, and the Casing-Casing Annulus #2 Pressure substantially equals a Casing-Casing Annulus #2 Pressure from the day prior, which substantially equals a Casing-Casing Annulus #2 Pressure from two days prior.

13. A system, comprising:
one or more memory modules;
one or more hardware processors communicably coupled to the one or more memory modules, the one or more hardware processors configured to execute instructions stored on the one or more memory models to perform operations comprising:
evaluating a wellhead tubing pressure, a plurality of annuli pressures, a choke valve value, and flowrate at a well surface of a well in real-time;
generating an automated alert in response to the wellhead tubing pressure, plurality of annuli pressures, choke valve value, and flowrate satisfying at least one condition; and
advising a user of at least one well action to resolve the automated alert, wherein the advising is interactive messaging that provides well actions to resolve the automated alert.

14. The system of claim 13, comprising verifying existence of the at least one condition that caused the generation of the automated alert prior to advising the user.

15. The system of claim 13, wherein upon resolution of the automated alert, categorizing the well as a healthy well.

16. The system of claim 13, wherein the automated alert is stored by a tracking system, and the tracking system is updated according to well actions taken at the well.

17. The system of claim 13, wherein the automated alert is rendered at a dashboard of a data server.

18. An apparatus comprising a non-transitory, computer readable, storage medium that stores instructions that, when executed by at least one processor, cause the at least one processor to perform operations comprising:
evaluating a wellhead tubing pressure, a plurality of annuli pressures, a choke valve value, and flowrate at a well surface of a well in real-time;
generating an automated alert in response to the wellhead tubing pressure, plurality of annuli pressures, choke valve value, and flowrate satisfying at least one condition; and
advising a user of at least one well action to resolve the automated alert, wherein the advising is interactive messaging that provides well actions to resolve the automated alert.

19. The apparatus of claim 18, comprising verifying existence of the at least one condition that caused the generation of the automated alert prior to advising the user.

20. The apparatus of claim 18, wherein upon resolution of the automated alert, categorizing the well as a healthy well.
